(19) United States
(12) Patent Application Publication
(10) Pub. No.: US 2016/0262345 A1
(43) Pub. Date: Sep. 15, 2016

(54) Double Wall Insulated Pet Bowl with Lid

(71) Applicants: James Gitter, Jensen Beach, FL (US); Kary Frebraro-Gitter, Jensen Beach, FL (US)

(72) Inventors: James Gitter, Jensen Beach, FL (US); Kary Frebraro-Gitter, Jensen Beach, FL (US)

(21) Appl. No.: 14/656,232

(22) Filed: Mar. 12, 2015

(51) Int. Cl. A01K 5/01; A01K 7/00

(52) U.S. Cl. CPC A01K 5/0114; A01K 5/0135; A01K 7/005

(57) ABSTRACT

The present invention relates to designing a non-skid, attractive pet bowl that is made up of a material, which is free of chemicals and Bisphenol A (BPA). The pet bowl is a double layered bowl with air acting as an insulator placed in between the two layers to keep the food or liquid temperature constant. The lid cover provided on the top of the pet bowl has a siliconized rubber ring contour that fits into top of the pet bowl and makes the pet bowl spill proof while carrying the pet bowl by maintaining the temperature of the food constant. Additionally, the bottom area of the pet bowl is provided with a non-skid gripping material to avoid tumbling of the food while the pet is eating the food or drinking liquid placed inside the pet bowl. Further, the outer part of the inner layer of the pet bowl is decorated to look attractive.

### FIELD OF THE INVENTION

The present invention generally relates to designing an attractive, insulated, and a safe pet bowl and more particularly relates to designing a pet bowl with a chemical and Bisphenol A (BPA) free material, wherein the pet bowl is doubled walled and blow molded for insulating from outside atmosphere, and can be custom decorated on the outside of the inner layer.

### BACKGROUND OF THE INVENTION

The pet bowls that are available in the market are generally made up of material such as stainless steel or plastic. As the material used to make the pet bowls is not claimed to be free of any chemical or BPA, the pet bowls can be harmful to the pet lives when used as food/liquid containers for a long duration. Further, the food/liquid temperature can be dissipated as the pet bowl is not well insulated to maintain the food/liquid temperature.

Accordingly, there exists a need for a pet bowl that is created by using chemical free and/or BPA free material. A pet bowl created by using chemical free and/or BPA free material enhances the safety measure while storing the food/liquid in the pet bowl. Further, the pet bowl must be capable of maintaining the temperature of the food/liquid that is placed in the pet bowl.

### SUMMARY OF THE INVENTION

The present invention relates to designing a non-skid double-walled insulated pet bowl for feeding animals that is free of Bisphenol A (BPA) and any other chemical, and the bowl is covered with a lid. The pet bowl comprises of an outer layer, an inner layer, and a bottom area. The outer layer and the inner layer of the bowl are made up of the same, blow molded materials fused together in a way that the inner layer is manually placed and held within the outer layer by using an adhesive or welding the layers. Further, the outer layer and the inner layer are separated by air, thus insulating the bowl from outside atmospheric conditions to keep the food/liquid temperature constant inside the pet bowl. Additionally, the outer part of the inner layer can be custom decorated to make the pet bowl look attractive and the bottom area is provided with a non-skid gripping material such as silicone granules, synthetic rubber, or the like to ensure that the pet bowl does not tumble while the pet is eating or drinking the food or water (liquid) placed inside the pet bowl. Further, the pet bowl is provided with a lid that has a siliconized rubber ring contour for closing the top portion of the pet bowl.

### BRIEF DESCRIPTION OF DRAWINGS

FIG. 1 illustrates a design overview of a pet bowl and lid.

FIG. 2 illustrates an overview of the pet bowl with a lid cover.

FIGS. 3a and 3b illustrate an overview and bottom portion of the lid cover.

FIG. 4 illustrates a side-view of the pet bowl with the lid cover.

FIG. 5 illustrates a siliconized rubber ring contour encasing the top of the pet bowl

### FIGURE DESCRIPTION

100—A pet bowl with a lid cover
101—Inner hollow layer of the pet bowl
102—Outside hollow layer of the pet bowl
103—Air trapped in between the inner layer and the outer layer
104—Decoration performed on the outer part of the inner layer
105—Bottom area of the pet bowl
106—A lid cover
200—Side-view of the lid cover
201—Bottom portion of the lid cover
202—A siliconized rubber ring contour that fits into top of the pet bowl

### DETAILED DESCRIPTION OF THE INVENTION

The following detailed description of the preferred embodiments presents a description of certain specific embodiments to assist in understanding the claims. However, the present invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be evident to one of ordinary skill in the art that the present invention may be practiced without these specific details.

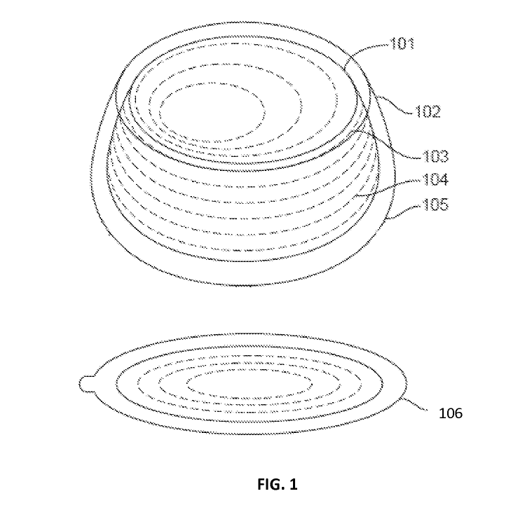

Referring to FIG. 1 illustrates a design overview of a pet bowl. As depicted in the figure, the pet bowl 100 is made up of two layers, an inner layer 101 and an outer layer 102. The two layers are fused together with air used as an insulator 103. In an embodiment, the inner layer 101 is placed within the outer layer 102 and the two layers are fabricated together. Further, the two layers of the pet bowl 100 can be made of BPA free Polymer or plastic or the like. In an embodiment, the bottom area 105 of the pet bowl 100 can be provided with non-skid gripping material such as silicone granules, synthetic rubber or the like. The non-skid gripping material keeps the pet bowl 100 in an upright position without allowing the pet bowl 100 to tumble while the pet eats the food or drinks the liquid that is placed in the pet bowl 100. In an embodiment, the pet bowl 100 is provided with a lid 106 to close the top portion of the pet bowl 100 and the lid 106 can be a detachable lid. In another embodiment, the lid 106 can be attached at the top portion of the pet bowl 100. In an embodiment, the outer part of the inner layer 101 of the pet bowl 100 is decorated 104 like a “Tervis” tumbler to enhance the attractiveness of the pet bowl 100. Further, the decoration on the outer part of the inner layer 104 can be customized based on the user's/customer's requirement. In an embodiment, the food or liquid placed in the pet bowl 100 can be maintained at a constant temperature due to the double walled insulation of air with or without use of the lid 106 closed on the pet bowl 100.

In an embodiment, the lid 106 has a siliconized rubber ring contour 202 that fits into top of the pet bowl 100. The siliconized rubber ring contour 202 creates a seal for the pet bowl 100 and allows the user to carry the pet bowl 100 by making the pet bowl 100 spill proof. Further, the sealed pet bowl 100 maintains the temperature of the food/liquid constant while carrying the pet bowl 100.

In an embodiment, the bottom portion of the lid 106 is positioned in such a way that the lid covers the food or liquid placed in the pet bowl 100.

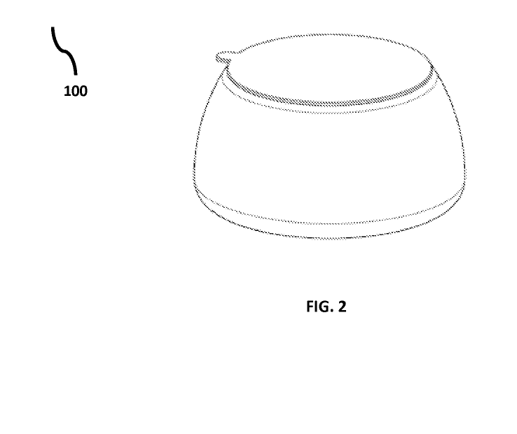

Referring to FIG. 2 illustrates an overview of a pet bowl 100 with a top lid 106 covering the pet bowl 100.

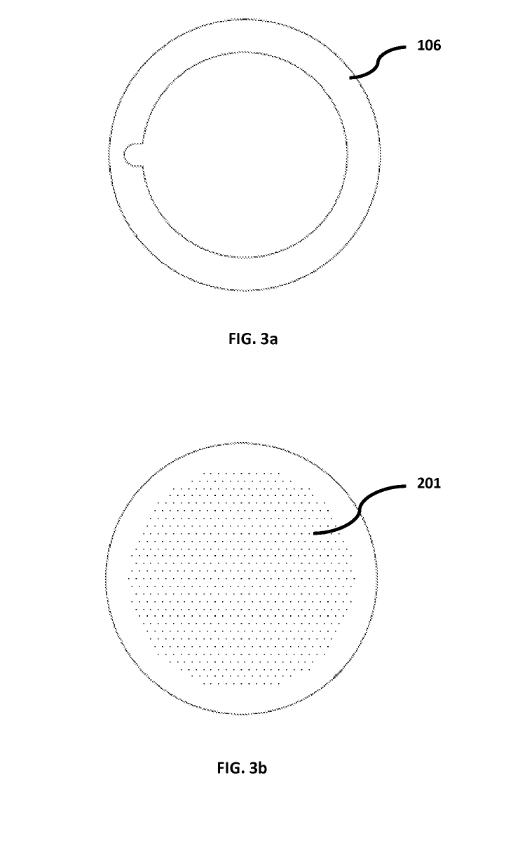

Referring to FIGS. 3a and 3b illustrate a top lid 106 with the bottom portion 201 for covering the pet bowl 100.

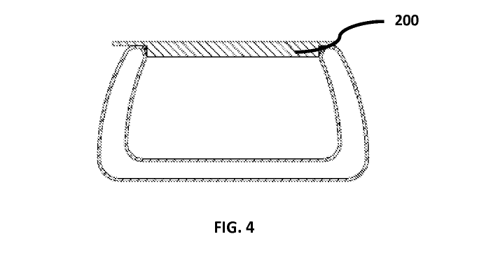

Referring to FIG. 4 illustrates a side view of the pet bowl 100 and top lid 106 with the siliconized rubber ring contour 202 used to create a seal for the pet bowl 100.

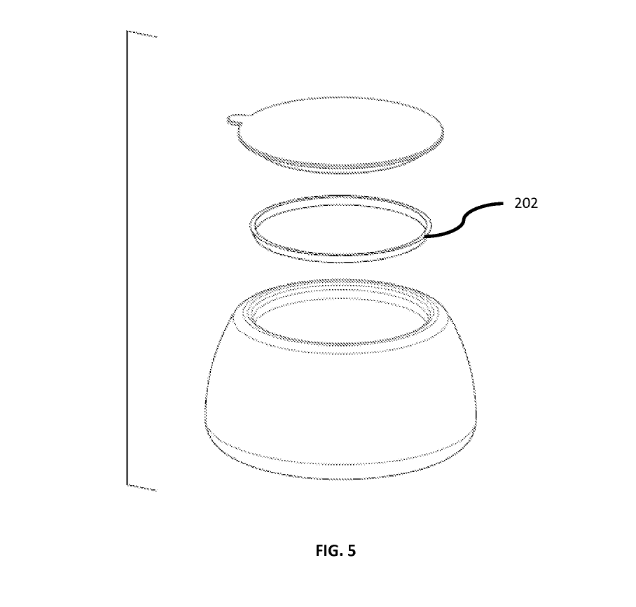

Referring to FIG. 5 illustrates a top lid 106 with the siliconized rubber ring contour 202 used to create a seal for the pet bowl 100.

1. A non-skid double-walled insulated pet bowl for feeding or hydrating animals that is free of Bisphenol A (BPA) and any other chemical, wherein said bowl is covered with a lid and said bowl comprises of:
an outer layer, an inner layer, and a bottom area fitted with a non-skid gripping material.

2. The non-skid double-walled insulated pet bowl as claimed in claim 1, wherein said outer layer and said inner layer of said bowl are made up of the same materials fused together in a way such that said inner layer is manually placed and held within said outer layer.

3. The non-skid double-walled insulated pet bowl as claimed in claim 1, wherein said outer layer and said inner layer are fabricated together by trapping air as an insulator in between said outer layer and said inner layer.

4. The non-skid double-walled insulated pet bowl as claimed in claim 1, wherein the outer part of said inner layer can be decorated as per the customer's requirement to enhance the attractiveness of said pet bowl.

5. The non-skid double-walled insulated pet bowl as claimed in claim 1, wherein said bottom layer of said pet bowl is provided with a non-skid gripping material such as silicone, synthetic rubber, or the like.

6. The non-skid double-walled insulated pet bowl as claimed in claim 1, wherein said pet bowl keeps the food or liquid temperature constant for long hours as the pet bowl is insulated by the entrapment of air in between the two layers.

7. The non-skid double-walled insulated pet bowl as claimed in claim 1, wherein said lid covering said pet bowl can be either a detachable lid or said lid can be attached externally to said outer layer of said pet bowl that covers the food or liquid placed in said pet bowl from top of said pet bowl.

8. The non-skid double-walled insulated pet bowl as claimed in claim 7, wherein said lid covering said pet bowl has a siliconized rubber ring contour for sealing the top portion of said pet bowl.

9. The non-skid double-walled insulated pet bowl as claimed in claim 8, wherein said pet bowl that is sealed allows the user to carry said pet bowl by making said pet bowl spill proof and by maintaining the temperature of food or liquid placed in said pet bowl constant.

10. The non-skid double-walled insulated pet bowl as claimed in claim 7, wherein the bottom portion of the lid is positioned in such a way that the lid covers the food or liquid placed in the pet bowl.
